(19) United States
(12) Patent Application Publication
(10) Pub. No.: US 2013/0346580 A1
(43) Pub. Date: Dec. 26, 2013

(54) APPARATUS AND METHOD FOR GENERATING QOS PROFILE FOR SUPPORTING DATA DISTRIBUTION SERVICE IN CYBER-PHYSICAL SYSTEM

(71) Applicant: Electronics and Telecommunications Research Institute, Daejeon-city (KR)

(72) Inventors: Yong-Yeon KIM, Daejeon (KR); Soo-Hyung LEE, Daejeon (KR); Hyung-Kook JUN, Seoul (KR); Kyung-Il KIM, Daejeon (KR); Kyeong-Tae KIM, Daejeon (KR); Won-Tae KIM, Asan-si (KR)

(73) Assignee: Electronics and Telecommunications Research Institute, Daejeon-city (KR)

(21) Appl. No.: 13/974,919

(22) Filed: Aug. 23, 2013

(30) Foreign Application Priority Data
Feb. 12, 2012 (KR) 10-2013-0014853

(51) Int. Cl. H04L 29/06

(52) U.S. Cl. CPC H04L 65/80
USPC 709/223

(57) ABSTRACT

Disclosed herein are an apparatus and method for generating a Quality of Service (QoS) profile. The apparatus includes a user interface unit, a resource QoS policy generation unit, a traffic QoS policy generation unit, and a QoS profile generation unit. The user interface unit receives a QoS policy for Data Distribution Service (DDS) from a user. The resource QoS policy generation unit collects resource data for a device that performs the DDS, and generates a QoS policy for handling resources using the collected resource data. The traffic QoS policy generation unit collects traffic data for a network via which the DDS is performed, and generates a QoS policy for handling traffic using the collected traffic data. The QoS profile generation unit generates a QoS profile based on the QoS policy received from the user, the QoS policy for handling resources, and the QoS policy for handling traffic.

### CROSS REFERENCE TO RELATED APPLICATION

This application claims the benefit of Korean Patent Application No. 10-2013-0014853, filed on Feb. 12, 2013, which is hereby incorporated by reference in its entirety into this application.

### BACKGROUND OF THE INVENTION

1. Technical Field

The present invention relates generally to an apparatus and method for generating a QoS profile for supporting Data Distribution Service (DDS) in a cyber-physical system and, more particularly, to an apparatus and method for generating a QoS profile that is capable of providing Quality of Service (QoS) policies suitable for an environment in which DDS is used in order to support DDS, that is, an open standard in accordance with which real-time data is distributed based on a publish/subscribe communication scheme that was defined by the Object Management Group (OMG).

2. Description of the Related Art

In a ubiquitous environment, there are many cases where a plurality of devices forms one network domain while dynamically operating in conjunction with each other, and exchanges data. In this environment, it is efficient to use an N:N communication scheme based on equality between devices participating in a domain rather than to use a server/client communication scheme using a central server. In connection with this N:N communication scheme, the OMG, that is, a software international standardization organization, released DDS, that is, standard communication middleware for providing efficient data distribution using a publish/subscribe communication scheme in an environment in which a network domain is dynamically formed and devices can freely participate in and withdraw from the domain. In particular, if DDS is used, a Cyber Physical System (CPS), such as a weather information service system, a transportation network management service system or a combat management system in which a plurality of embedded systems has been combined can be efficiently designed, implemented, and managed based on a network.

The paper “OMG Data-Distribution Service: Architectural Overview,” Distributed Computing Systems Workshops, 2003. Proceedings. On 23rd International Conference, pp. 200-206, Pardo-Castellote G., 19-22, May 2003, which was standardized and published by the OMG, discloses technology in which a plurality of unspecified participants (i.e., publishers or subscribers) is dynamically generated and an Application Programming Interface (API) that enables participants to publish and subscribe data using QoS is provided so that data-centric and real-time DDS is possible.

In technologies for implementing DDS that were proposed by conventional arts, such as in the above paper, a user should manually set parameter values for all 22 QoS policies or set the QoS policies to basic values when determining policies for the operation of DDS in a system environment in which the DDS is performed. In the case where a user directly sets parameter values for QoS policies or sets the QoS policies to basic values, if the user sets the values for the QoS policies without being aware of an environment in which the DDS is performed, a problem arises in that communication through which data is exchanged in DDS middleware may not operate in accordance with the environment or the communication itself may not be performed. Furthermore, the conventional technologies do not provide a profile for QoS policies that have been suitably set for a system environment.

### SUMMARY OF THE INVENTION

Accordingly, the present invention has been made keeping in mind the above problems occurring in the prior art, and an object of the present invention is to provide a method of collecting information about the physical resources of a device using DDS and information about communication and a network via which the DDS is performed and then generating a QoS profile using the collected information in order to solve a problem in which a user should accurately know a physical system or a network environment to set parameter values for the QoS policies of the DDS so that the user can efficiently set the 22 QoS policies of a DDS system in accordance with a system environment.

In accordance with an aspect of the present invention, there is provided an apparatus for generating a Quality of Service (QoS) profile, including a user interface unit configured to receive a QoS policy for Data Distribution Service (DDS) from a user; a resource QoS policy generation unit configured to collect resource data for a device that performs the DDS, and to generate a QoS policy for handling resources using the collected resource data; a traffic QoS policy generation unit configured to collect traffic data for a network via which the DDS is performed, and to generate a QoS policy for handling traffic using the collected traffic data; and a QoS profile generation unit configured to generate a QoS profile based on the QoS policy received from the user, the QoS policy for handling resources, and the QoS policy for handling traffic.

The resource QoS policy generation unit may include a resource data collection unit configured to collect the resource data from the device that performs the DDS; a resource data mapping unit configured to set the QoS policy for handling resources by mapping the collected resource data to a parameter value of the QoS policy for handling resources; and a resource QoS policy provision unit configured to transfer the set QoS policy for handling resources to the QoS profile generation unit.

The QoS policy for handling resources may include one or more of QoS policies “resource limits,” “history,” “durability,” “lifespan,” “reader data lifecycle,” “writer data lifecycle,” “content filters,” “user data,” “topic data,” and “group data.”

The traffic QoS policy generation unit may include a traffic data collection unit configured to collect the traffic data from the network via which the DDS is performed; a traffic data mapping unit configured to set the QoS policy for handling traffic by mapping the collected traffic data to a parameter value for the QoS policy for handling traffic; and a traffic QoS policy provision unit configured to transfer the set QoS policy for handling traffic to the QoS profile generation unit.

The QoS policy for handling traffic may include one or more of QoS policies “deadline,” “liveliness,” “latency budget,” “transport priority,” “time based filter,” and “reliability.”

The user interface unit may receive only a QoS policy for processing data published or subscribed through the DDS from the user.

The QoS policy for processing data may include one or more of QoS policies “partition,” “destination order,” “ownership,” “ownership strength,” “presentation,” and “destination order.”

In accordance with an aspect of the present invention, there is provided a method of generating a Quality of Service (QoS) profile, including receiving, by a user interface unit, a QoS policy for DDS from a user; collecting, by a resource QoS policy generation unit, resource data for a device that performs the DDS, and generating, by the resource QoS policy generation unit, a QoS policy for handling resources using the collected resource data; collecting, by a traffic QoS policy generation unit, traffic data for a network via which the DDS is performed, and generating, by the traffic QoS policy generation unit, a QoS policy for handling traffic using the collected traffic data; and generating, by a QoS profile generation unit, a QoS profile based on the QoS policy received from the user, the QoS policy for handling resources, and the QoS policy for handling traffic.

Generating the QoS policy for handling resources may include collecting, by a resource data collection unit, the resource data from the device that performs the DDS; setting, by a resource data mapping unit, the QoS policy for handling resources by mapping the collected resource data to a parameter value for the QoS policy for handling resources; and transferring, by a resource QoS policy provision unit, the set QoS policy for handling resources to the QoS profile generation unit.

The QoS policy for handling resources may include one or more of QoS policies “resource limits,” “history,” “durability,” “lifespan,” “reader data lifecycle,” “writer data lifecycle,” “content filters,” “user data,” “topic data,” and “group data.”

Generating the QoS policy for handling traffic may include collecting, by a traffic data collection unit, the traffic data from the network via which the DDS is performed; setting, by a traffic data mapping unit, the QoS policy for handling traffic by mapping the collected traffic data to a parameter value of the QoS policy for handling traffic; and transferring, by a traffic QoS policy provision unit, the set QoS policy for handling traffic to the QoS profile generation unit.

The QoS policy for handling traffic may include one or more of QoS policies “deadline,” “liveliness,” “latency budget,” “transport priority,” “time based filter,” and “reliability.”

Receiving the QoS policy for the DDS from the user may include receiving only a QoS policy for processing data published or subscribed through the DDS from the user.

The QoS policy for processing data may include one or more of QoS policies “partition,” “destination order,” “ownership,” “ownership strength,” “presentation,” and “destination order.”

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically showing the structure of DDS middleware for the exchange of data through the publication/subscription of data;

FIG. 2 is a block diagram illustrating the configuration of an apparatus for generating a QoS profile according to the present invention;

FIG. 3 is a block diagram illustrating the configuration of the resource QoS policy generation unit shown in FIG. 2;

FIG. 4 is a block diagram illustrating the configuration of the traffic QoS policy generation unit shown in FIG. 2; and

FIGS. 5 to 7 are flowcharts illustrating a method of generating a QoS profile according to the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily vague will be omitted below. The embodiments of the present invention are intended to fully describe the present invention to a person having ordinary knowledge in the art. Accordingly, the shapes, sizes, etc. of elements in the drawings may be exaggerated to make the description clear.

In general, an application program is dependent upon a communication protocol suitable for a network and a service environment. A problem in which an application program is dependent upon a communication protocol may be solved via middleware that performs a communication function between an application layer and an Operating System (OS) layer as a proxy.

DDS was defined by the OMG for the purposes of data-centric real-time data distribution, and data may be published to and subscribed by a plurality of unspecified participants over a network through the DDS.

If participants frequently exchange data of the same type within a network, a data-centric communication scheme is appropriate. Furthermore, if the number of participants participating in a network is large and registration and the release of registration are dynamically performed, the exchange of data using a method of publishing and subscribing desired data without being aware of a counterpart is more efficient than the exchange of data using a server/client method in which an application program searches for a counterpart with which data will be exchanged and connects counterparts. Publishers who publish data and subscribers who subscribe the data gather to set one domain, and data samples of an agreed type are distributed in a multicast manner.

Accordingly, when performing efficient and rapid data distribution using a multicast and broadcast mechanism, a plurality of participants belonging to a network domain in DDS is classified into publishers who provide data and subscribers who are supplied with the data depending on their roles, and only participants having the same topic within a network perform communication with each other. When participants exchange data using a topic, the topic is the type of data that publishers and subscribers exchange within a domain. The topic is defined in various manners for the purposes of data-centric real-time data distribution in accordance with a data message standard.

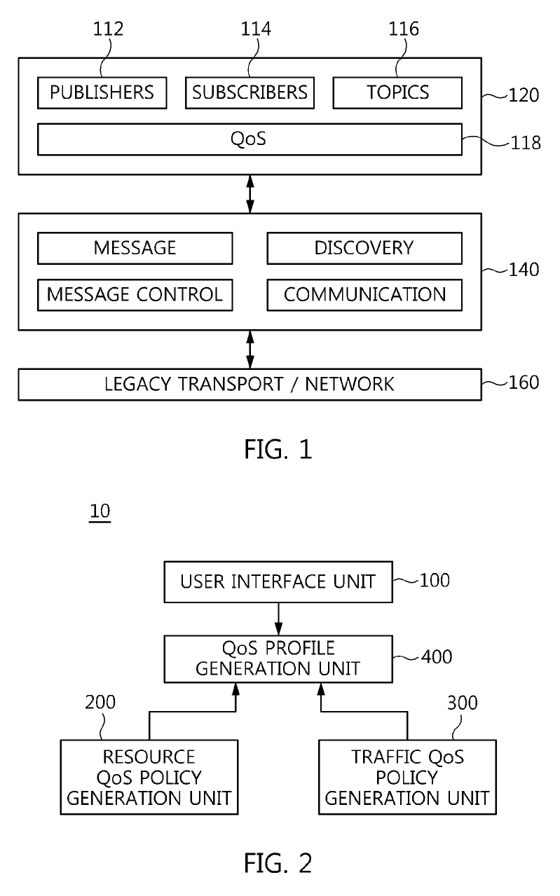

Referring to the structure of DDS middleware defined by the OMG and schematically shown in FIG. 1, the DDS middleware includes Data-Centric Publish-Subscribe (DCPS) 120 for implementing QoS for data communication, and Real-Time Publish-Subscribe (RTPS) 140.

The DCPS 120 is a functional interface layer for the publication and subscription of data that is provided to an application program. The application program may perform the publication and subscription of data without being aware of another participant who desires to exchange data through the DCPS 120.

The RTPS 140 is a layer for published and subscribed real data. In this case, a network 160 may determine the type of data to be exchanged, dynamically search for another participant with which data will be exchanged, and transmit and receive data to and from the retrieved participant through the RTPS 140.

In connection with QoS 118 that is one of important characteristics provided by this DDS, the QoS 118 collects service characteristics in the DDS, and provides different QoS policies to publishers 112, subscribers 114, and topics 116. In this case, the DDS may provide a total of 22 QoS policies. The 22 QoS policies are shown in the following Table 1:

TABLE 1
QoS POLICIES

| Durability | User Data | Ownership | Reliability |
|---|---|---|---|
| History | Topic Data | Ownership Strength | Time Based Filter |
| Reader Data | Group Data | Liveliness | Deadline |
| Lifecycle | | | |
| Writer Data | Partition | Latency Budget | Content Filters |
| Lifecycle | | | |
| Lifespan | Presentation | Transport Priority | |
| Entity | Destination Order | Resource Limits | |
| Factory | | | |

The QoS policies shown in Table 1 will be described in brief below. First, “durability” is a policy for the durability of data. “User data,” “topic data,” and “group data” are policies that are used to allow additional information to be attached to data or a topic, a publisher, and a subscriber. “Partition” is a policy for a logical communication channel. “Destination order” is a policy for the arrangement of data. “Ownership” and “ownership strength” are policies that are used to indicate the weight of data. “Presentation” is a policy that is used to provide notification of a change. “Destination order” is a policy for the arrangement of data. “Resource limits” and “history” are policies for the storage of data. “Lifespan” is a policy for the available period of data. “Reader data lifecycle and “writer data lifecycle” are policies for the life cycles of a publisher and a subscriber. “Content filters” is a policy for data filtering through content. “Deadline” is a policy for a data transfer cycle. “Liveliness” is a policy that is used to provide notification that a publisher and a subscriber are alive. “Latency budget” is a policy that is used to guarantee a maximum communication delay time. “Transport priority” is a policy for data communication based on priority. “Time based filter” is a policy for data filtering over time. “Reliability” is a policy that is used to guarantee the reliability of data communication.

These QoS policies are classified according to their functions, as follows. First, “partition,” “destination order,” “ownership,” “ownership strength,” “presentation,” and “destination order” correspond to QoS policies that are used to process data in the DDS. Second, “resource limits,” “history,” “durability,” “lifespan,” “reader data lifecycle,” “writer data lifecycle,” “content filters,” “user data,” “topic data,” and “group data” correspond to QoS policies that are used to handle resources in the DDS. Third, “deadline,” “liveliness,” “latency budget,” “transport priority,” “time based filter,” and “reliability” correspond to QoS policies that are used to handle communication and the traffic of a network.

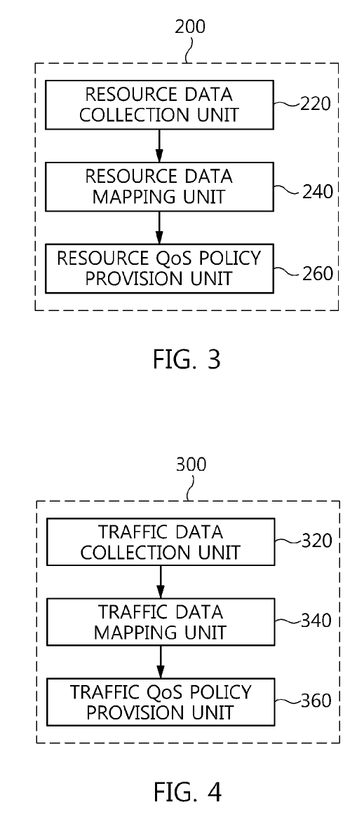

The configuration and operation of an apparatus for generating a QoS profile to support DDS in a cyber-physical system according to the present invention will be described below with reference to FIGS. 2 to 4.

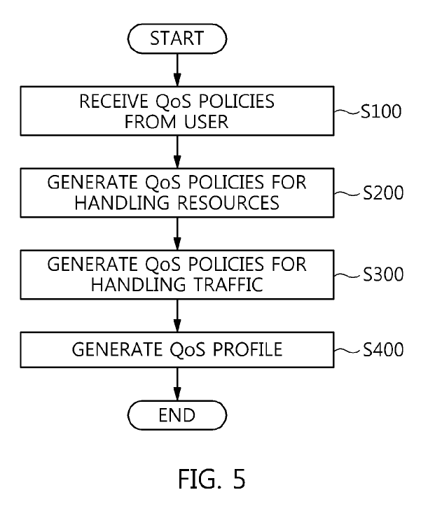

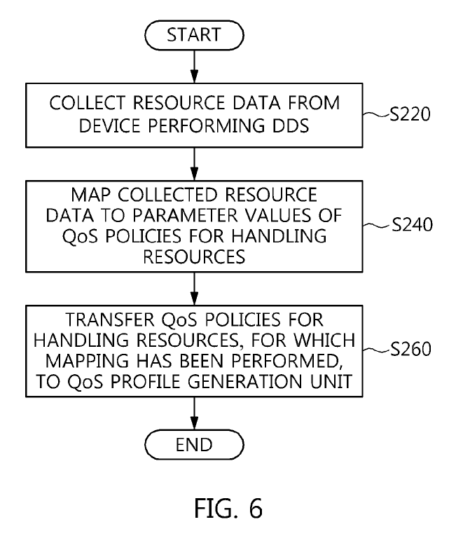

FIG. 2 is a block diagram illustrating the configuration of an apparatus for generating a QoS profile according to the present invention, FIG. 3 is a block diagram illustrating the configuration of the resource QoS policy generation unit shown in FIG. 2, and FIG. 4 is a block diagram illustrating the configuration of the traffic QoS policy generation unit shown in FIG. 2.

Referring to FIG. 2, the apparatus for generating a data QoS profile according to the present invention includes a user interface unit 100, a resource QoS policy generation unit 200, a traffic QoS policy generation unit 300, and a QoS profile generation unit 400.

The user interface unit 100 receives the QoS policies of the DDS from a user, and transfers the QoS policies to the QoS profile generation unit 400. That is, the user interface unit 100 may display various QoS policies for the DDS to a user, and may receive QoS policies for which parameter values have been directly set by a user. The user interface unit 100 may receive parameter values that are set for all the QoS policies of Table 1. In the present invention, however, the user interface unit 100 may present only QoS policies for processing data published or subscribed through the DDS, which belong to the QoS policies of Table 1, to a user, and receive parameter values that are set only for the presented QoS policies. Furthermore, the user interface unit 100 transfers QoS policies for which parameter values have been set by a user to the QoS profile generation unit 400.

The resource QoS policy generation unit 200 collects resource data for a device that performs DDS, and generates QoS policies for handling resources using the collected resource data.

More specifically, referring to FIG. 3, the resource QoS policy generation unit 200 includes a resource data collection unit 220, a resource data mapping unit 240, and a resource QoS policy provision unit 260.

The resource data collection unit 220 collects data about resources (e.g., the specification data of hardware resources, such as a CPU, RAM, or a disk) while the participant (i.e., publisher or subscriber) of the DDS is being generated from a device that performs the DDS, and sends the collected resource data to the resource data mapping unit 240.

The resource data mapping unit 240 maps the resource data collected by the resource data collection unit 220 to the parameter value of a QoS policy. In this case, the QoS policy for which the collected resource data has been mapped to the parameter value by the resource data mapping unit 240 is one or more QoS policies for handling resources, which belong to the QoS policies of Table 1, and corresponds to one or more of the QoS policies “resource limits,” “history,” “durability,” “lifespan,” “reader data lifecycle,” “writer data lifecycle,” “content filters,” “user data,” “topic data,” and “group data.” Furthermore, the resource data mapping unit 240 sends the QoS policies for handling resources, which are generated by mapping the resource data to the parameter value, to the resource QoS policy provision unit 260.

The resource QoS policy provision unit 260 transfers the QoS policies for handling resources, which are generated by the resource data mapping unit 240, to the QoS profile generation unit 400.

The traffic QoS policy generation unit 300 collects data about the traffic of communication and a network via which DDS is performed, and generates QoS policies for handling traffic using the collected traffic data.

More specifically, referring to FIG. 4, the traffic QoS policy generation unit 300 includes a traffic data collection unit 320, a traffic data mapping unit 340, and a traffic QoS policy provision unit 360.

The traffic data collection unit 320 collects data (e.g., data about the measurement of RTT, jitter, or latency) about the traffic of communication and a network via which the DDS is performed while the participant (i.e., a publisher or a subscriber) of the DDS is being searched for, and sends the collected traffic data to the traffic data mapping unit 340.

The traffic data mapping unit 340 maps the traffic data collected by the traffic data collection unit 320 to the parameter value of a QoS policy. In this case, the QoS policy for which the collected traffic data has been mapped to the parameter value by the traffic data mapping unit 340 is one or more QoS policies for handling traffic, which belong to the QoS policies of Table 1. The QoS policy includes one or more of the QoS policies “deadline,” “liveliness,” “latency budget,” “transport priority,” “time based filter,” and “reliability.” Furthermore, the traffic data mapping unit 340 sends the QoS policies for handling traffic, which are generated by mapping the traffic data to the parameter value, to the traffic QoS policy provision unit 360.

The traffic QoS policy provision unit 360 transfers the QoS policies for handling traffic, which are generated by the traffic data mapping unit 340, to the QoS profile generation unit 400.

The QoS profile generation unit 400 generates a QoS profile based on the QoS policy, for which the parameter value has been set by the user and which has been received from the user interface unit 100, the QoS policies for handling resources, for which the resource data has been mapped and which are received from the resource QoS policy provision unit 260, and the QoS policies for handling traffic, for which the traffic data has been mapped and which are received from the traffic QoS policy provision unit 360. In this case, if the user interface unit 100 receives all the QoS policies for which the parameter values have been set by a user, the QoS profile generation unit 400 generates a QoS profile by replacing QoS policies for handling resources, which belong to all the QoS policies received from the user interface unit 100, with QoS policies for handling resources, which are received from the resource QoS policy provision unit 260, and replacing QoS policies for handling traffic, which belong to all the QoS policies received from the user interface unit 100, with QoS policies for handling traffic, which are received from the traffic QoS policy provision unit 360.

Meanwhile, if the user interface unit 100 receives only QoS policies for processing data, for which parameter values have been set by a user, the QoS profile generation unit 400 generates a QoS profile by integrating QoS policies for processing data, which are received from the user interface unit 100, QoS policies for handling resources, which are received from the resource QoS policy provision unit 260, and QoS policies for handling traffic, which are received from the traffic QoS policy provision unit 360. The QoS profile generation unit 400 provides the generated QoS profile to DDS middleware. The DDS middleware performs DDS suitable for the QoS policies included in the QoS profile, based on the QoS profile that is received from the QoS profile generation unit 400.

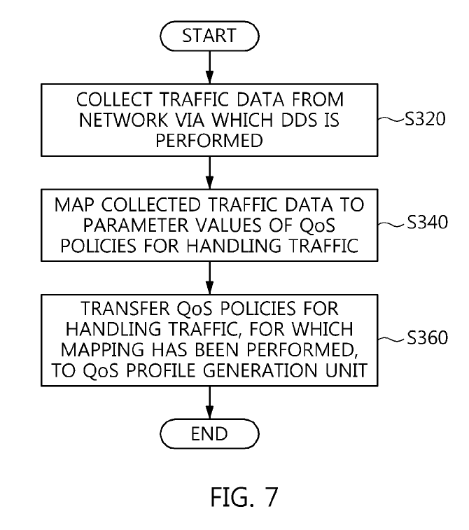

A method of generating a QoS profile to support DDS in a cyber-physical system according to the present invention will be described below with reference to FIGS. 5 to 7. Descriptions of the method of generating a QoS profile that are identical to those of the operation of the apparatus for generating a QoS profile to support DDS in a cyber-physical system described with reference to FIGS. 2 to 4 according to the present invention will be omitted below.

FIG. 5 is a flowchart illustrating a method of generating a QoS profile according to the present invention.

Referring to FIG. 5, in the method of generating a QoS profile according to the present invention, first, the user interface unit 100 receives QoS policies for DDS from a user at step S100. In this case, the user interface unit 100 may receive only one or more of the QoS policies “partition,” “destination order,” “ownership,” “ownership strength,” “presentation,” and “destination order,” that is, QoS policies for processing data published or subscribed through the DDS from the user. The user interface unit 100 provides the QoS profile generation unit 400 with the QoS policies received from the user at step S100.

Thereafter, the resource QoS policy generation unit 200 collects resource data for a device that performs the DDS and generates QoS policies for handling resources using the collected resource data at step S200. The resource QoS policy generation unit 200 provides the QoS policies for handling resources, generated at step S200, to the QoS profile generation unit 400.

Furthermore, the traffic QoS policy generation unit 300 collects traffic data for a network via which the DDS is performed and generates QoS policies for handling traffic using the collected traffic data at step S300. The traffic QoS policy generation unit 300 provides the QoS policies for handling traffic, generated at step S300, to the QoS profile generation unit 400.

Step S300 of generating the QoS policies for handling traffic has been illustrated as being performed after step S200 of generating the QoS policies for handling resources in FIG. 5, but the order in which steps S200 and S300 are executed is not limited thereto. For example, in the method of generating a QoS profile according to the present invention, step S300 may be performed before step S200, or steps S200 and S300 may be performed in a parallel manner.

At step S400, the QoS profile generation unit 400 generates a QoS profile based on the QoS policies input by the user and received from the user interface unit 100 at step S100, the QoS policies for handling resources, which are received from the resource QoS policy generation unit 200 at step S200, and the QoS policies for handling, which are received from the traffic QoS policy generation unit 300 at step S300.

FIG. 6 is a flowchart illustrating, in greater detail, step S200 of generating the QoS policies for handling resources in the method of generating a QoS profile shown in FIG. 5.

Referring to FIG. 6, in step S200 of generating the QoS policies for handling resources, first, the resource data collection unit 220 collects resource data from a device that performs DDS at step S220. The resource data collection unit 220 sends the resource data, collected at step S220, to the resource data mapping unit 240.

The resource data mapping unit 240 sets QoS policies for handling resources by mapping the resource data, received from the resource data collection unit 220 at step S220, to the parameter values of the QoS policies for handling resources at step S240. The QoS policies for which the resource data has been mapped by the resource data mapping unit 240 at step S240 include one or more of the QoS policies “resource limits,” “history,” “durability,” “lifespan,” “reader data lifecycle,” “writer data lifecycle,” “content filters,” “user data,” “topic data,” and “group data.” Furthermore, the resource data mapping unit 240 sends the QoS policies for handling resources, set at step S240, to the resource QoS policy provision unit 260.

The resource QoS policy provision unit 260 transfers the set QoS policies for handling resources, for which the resource data has been mapped at step S240, to the QoS profile generation unit 400 at step S260.

FIG. 7 is a flowchart illustrating, in greater detail, step S300 of generating the QoS policies for handling traffic in the method of generating a QoS profile shown in FIG. 5.

Referring to FIG. 7, at step S300 of generating the QoS policies for handling traffic, first, the traffic data collection unit 320 collects traffic data from communication and a network via which DDS is performed at step S320. The traffic data collection unit 320 sends the traffic data, collected at step S320, to the traffic data mapping unit 340.

The traffic data mapping unit 340 sets QoS policies for handling traffic by mapping the traffic data, received from the traffic data collection unit 320 at step S320, to the parameter values of QoS policies for handling traffic at step S340. The QoS policies for handling traffic, for which the traffic data is mapped by the traffic data mapping unit 340 at step S340, include one or more of the QoS policies “deadline,” “liveliness,” “latency budget,” “transport priority,” “time based filter,” and “reliability.” Furthermore, the traffic data mapping unit 340 sends the QoS policies for handling traffic, set at step S340, to the traffic QoS policy provision unit 360.

The traffic QoS policy provision unit 360 transfers the QoS policies for handling traffic for which the traffic data has been mapped at step S340 to the QoS profile generation unit 400 at step S360.

Meanwhile, some steps of the above-described method of generating a QoS profile according to the present invention may be implemented in the form of program instructions that can be executed by various computing means (e.g., computer-readable code), and may be stored in a computer-readable storage medium. The computer-readable storage medium includes all types of storage devices in which computer system-readable data can be stored. Examples of the computer-readable storage medium are Read Only Memory (ROM), Random Access Memory (RAM), compact disk (CD)-ROM, magnetic tape, a floppy disk, an optical disk and a magneto-optical data storage device. Furthermore, the computer-readable storage medium may be implemented as carrier waves (for example, in the case of transmission over the Internet). Moreover, the computer-readable medium may be distributed across computer systems connected via a network, and thus computer-readable code can be stored and executed in a distributed manner.

The present invention is configured to collect information about system resources and information about a network environment, to set QoS policies that require the information about system resources and the information about a network environment, and to provide a QoS profile generated by combining the set QoS policies with QoS policies set by a user, thereby achieving the advantage of enabling efficient and stable DDS, in which a physical system environment and a network environment have been taken into consideration, to be performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating a Quality of Service (QoS) profile, comprising:
a user interface unit configured to receive a QoS policy for Data Distribution Service (DDS) from a user;
a resource QoS policy generation unit configured to collect resource data for a device that performs the DDS, and to generate a QoS policy for handling resources using the collected resource data;
a traffic QoS policy generation unit configured to collect traffic data for a network via which the DDS is performed, and to generate a QoS policy for handling traffic using the collected traffic data; and
a QoS profile generation unit configured to generate a QoS profile based on the QoS policy received from the user, the QoS policy for handling resources, and the QoS policy for handling traffic.

2. The apparatus of claim 1, wherein the resource QoS policy generation unit comprises:
a resource data collection unit configured to collect the resource data from the device that performs the DDS;
a resource data mapping unit configured to set the QoS policy for handling resources by mapping the collected resource data to a parameter value of the QoS policy for handling resources; and
a resource QoS policy provision unit configured to transfer the set QoS policy for handling resources to the QoS profile generation unit.

3. The apparatus of claim 2, wherein the QoS policy for handling resources comprises one or more of QoS policies “resource limits,” “history,” “durability,” “lifespan,” “reader data lifecycle,” “writer data lifecycle,” “content filters,” “user data,” “topic data,” and “group data.”

4. The apparatus of claim 1, wherein the traffic QoS policy generation unit comprises:
a traffic data collection unit configured to collect the traffic data from the network via which the DDS is performed;
a traffic data mapping unit configured to set the QoS policy for handling traffic by mapping the collected traffic data to a parameter value for the QoS policy for handling traffic; and
a traffic QoS policy provision unit configured to transfer the set QoS policy for handling traffic to the QoS profile generation unit.

5. The apparatus of claim 4, wherein the QoS policy for handling traffic comprises one or more of QoS policies “deadline,” “liveliness,” “latency budget,” “transport priority,” “time based filter,” and “reliability.”

6. The apparatus of claim 1, wherein the user interface unit receives only a QoS policy for processing data published or subscribed through the DDS from the user.

7. The apparatus of claim 6, wherein the QoS policy for processing data comprises one or more of QoS policies “partition,” “destination order,” “ownership,” “ownership strength,” “presentation,” and “destination order.”

8. A method of generating a Quality of Service (QoS) profile, comprising:
receiving, by a user interface unit, a QoS policy for DDS from a user;
collecting, by a resource QoS policy generation unit, resource data for a device that performs the DDS, and generating, by the resource QoS policy generation unit, a QoS policy for handling resources using the collected resource data;
collecting, by a traffic QoS policy generation unit, traffic data for a network via which the DDS is performed, and generating, by the traffic QoS policy generation unit, a QoS policy for handling traffic using the collected traffic data; and
generating, by a QoS profile generation unit, a QoS profile based on the QoS policy received from the user, the QoS policy for handling resources, and the QoS policy for handling traffic.

9. The method of claim 8, wherein generating the QoS policy for handling resources comprises:
collecting, by a resource data collection unit, the resource data from the device that performs the DDS;
setting, by a resource data mapping unit, the QoS policy for handling resources by mapping the collected resource data to a parameter value for the QoS policy for handling resources; and
transferring, by a resource QoS policy provision unit, the set QoS policy for handling resources to the QoS profile generation unit.

10. The method of claim 9, wherein the QoS policy for handling resources comprises one or more of QoS policies “resource limits,” “history,” “durability,” “lifespan,” “reader data lifecycle,” “writer data lifecycle,” “content filters,” “user data,” “topic data,” and “group data.”

11. The method of claim 8, wherein generating the QoS policy for handling traffic comprises:
collecting, by a traffic data collection unit, the traffic data from the network via which the DDS is performed;
setting, by a traffic data mapping unit, the QoS policy for handling traffic by mapping the collected traffic data to a parameter value of the QoS policy for handling traffic; and
transferring, by a traffic QoS policy provision unit, the set QoS policy for handling traffic to the QoS profile generation unit.

12. The method of claim 11, wherein the QoS policy for handling traffic comprises one or more of QoS policies “deadline,” “liveliness,” “latency budget,” “transport priority,” “time based filter,” and “reliability.”

13. The method of claim 8, wherein receiving the QoS policy for the DDS from the user comprises receiving only a QoS policy for processing data published or subscribed through the DDS from the user.

14. The method of claim 13, wherein the QoS policy for processing data comprises one or more of QoS policies “partition,” “destination order,” “ownership,” “ownership strength,” “presentation,” and “destination order.”
